(19) United States
(12) Patent Application Publication
(10) Pub. No.: US 2022/0417483 A1
(43) Pub. Date: Dec. 29, 2022

(54) IMAGE PROCESSING DEVICE, IMAGE PROCESSING METHOD, AND IMAGE PROJECTION SYSTEM

(71) Applicant: SONY GROUP CORPORATION, TOKYO (JP)

(72) Inventor: MASUYOSHI KUROKAWA, TOKYO (JP)

(21) Appl. No.: 17/756,520

(22) PCT Filed: Oct. 9, 2020
(86) PCT No.: PCT/JP2020/038405

§ 371 Date: May 26, 2022

(30) Foreign Application Priority Data
Dec. 5, 2019 (JP) 2019-220759

(51) Int. Cl. H04N 9/31

(52) U.S. Cl. CPC H04N 9/3194; H04N 9/3185

(57) ABSTRACT

Provided is an image processing device that processes a projection image of a projector.

The image processing device includes: a detection unit that detects an error in a region based on an error detection function assigned to each region of a predetermined pattern extracted from a first image; and an acquisition unit that acquires corresponding point information of a region in an original predetermined pattern based on an identification function assigned to each region of the predetermined pattern extracted from the first image. The original predetermined pattern is configured to satisfy a first constraint condition for each of the regions made up of 3×3 dots that a central dot has an attribute value of 3 and the modulo 3 of a sum of attribute values of eight dots around the central dot is 0.

### TECHNICAL FIELD

The technology (hereinafter referred to as “the present disclosure”) disclosed in the present specification relates to an image processing device and an image processing method for processing a projection image of a projector, and an image projection system.

### BACKGROUND ART

Projection technology for projecting a video on screens has been known for a long time and is widely used in an educational field, conferences, and presentations. Since a video can be enlarged and displayed on a relatively large screen, there is an advantage that the same image can be presented to a plurality of persons at the same time. Recently, projection mapping for projecting and displaying a video on the surface of a screen having an arbitrary shape such as a building, and projector stacking in which images are superimposed and projected on the same projection surface using a plurality of projectors have also been used. It's coming.

In order to reduce distortion of a projection image in various environments or to align the projection images from a plurality of projectors, it is necessary to grasp the projection status of the projectors. Generally, a method of projecting a test pattern from a projector, capturing the projection image with a camera, and performing geometric correction on the original video based on the correspondence relationship between the original test pattern and the test pattern on the captured image has been used.

Usually, the projection status of the projector is grasped before the projection is started. Further, even during the projection of a video, the posture of a projector and the shape of a projection surface may change due to the influence of disturbance such as temperature and vibration. Therefore, even after the projection is started, it is necessary to grasp the projection status of the projector and correct the video again. It is not preferable for the presenter and the audience to stop the projection operation and interrupt the presentation every time the projection status of the projector is checked. Therefore, online sensing has been proposed in which the projection status of the projector is checked while continuing the projection operation of a video (see, for example, PTL 1).

### CITATION LIST

### Patent Literature

[PTL 1]
WO 2017/104447

### SUMMARY

### Technical Problem

An object of the present disclosure is to provide an image processing device and an image processing method for processing a projection image including a predetermined pattern, and an image projection system.

A first aspect of the present disclosure provides an image processing device including: a detection unit that detects an error in a region based on an error detection function assigned to each region of a predetermined pattern extracted from a first image; and an acquisition unit that acquires corresponding point information of a region in an original predetermined pattern based on an identification function assigned to each region of the predetermined pattern extracted from the first image.

Each dot has an attribute value represented by 2 bits of 0 to 3, and the original predetermined pattern is configured to satisfy the first constraint condition for each of the regions made up of 3×3 dots that a central dot has an attribute value of 3 and the modulo 3 of a sum of attribute values of eight dots around the central dot is 0.

The detection unit detects an error in a region made up of 3×3 dots based on whether the modulo 3 of the sum of the attribute values of eight dots around the dot having the attribute value of 3 detected from the extracted predetermined pattern is 0.

The acquisition unit acquires corresponding point information based on a comparison result between the sequence of the attribute values of eight dots around the dot having the attribute value of 3 detected from the extracted predetermined pattern and a sequence of attribute values in an original predetermined pattern.

A second aspect of the present disclosure provides an image processing method including: a detection step of detecting an error in a region based on an error detection function assigned to each region of a predetermined pattern extracted from a first image; and an acquisition step of acquiring corresponding point information of a region in an original predetermined pattern based on an identification function assigned to each region of the predetermined pattern extracted from the first image.

A third aspect of the present disclosure provides an image projection system including: a projector; a camera that captures a projection image of the projector; a detection unit that extracts a predetermined pattern from a captured image obtained by the camera capturing a projection image of an image in which the predetermined pattern is embedded, projected by the projector and detects an error in each region of the extracted predetermined pattern based on an error detection function assigned to each of the predetermined pattern; an acquisition unit that acquires corresponding point information for each region of the extracted predetermined pattern based on an identification function assigned to each region of the predetermined pattern; and an image correction unit that corrects an image projected from the projector based on the acquired corresponding point information.

However, the “system” mentioned here means a logical set of a plurality of devices (or functional modules that realize specific functions) and whether each device or functional module is disposed in a single housing does not particularly matter.

### Advantageous Effects of Invention

According to the present disclosure, it is possible to provide an image processing device and an image processing method for checking the projection status of a projector by online sensing, and an image projection system.

Note that the effects described in the present specification are merely examples, and the effects provided by the present disclosure are not limited thereto. In addition to the above effects, the present disclosure may have additional effects.

Other objects, features, and advantages of the present disclosure will become clear according to detailed description based on embodiments which will be described later and the attached drawings.

### BRIEF DESCRIPTION OF DRAWINGS

FIG. 1 is a diagram showing an example of an external configuration of an image projection system 100.

FIG. 2 is a diagram showing a functional configuration example of the image projection system 100.

FIG. 3 is a diagram showing an example of an internal configuration of a projection unit 201.

FIG. 4 is a diagram showing an example of an internal configuration of an image processing unit 202.

FIG. 5 is a diagram for explaining the operating principle of an ISL method.

FIG. 6 is a diagram showing an embodiment of a structured light pattern 600.

FIG. 7 is a diagram showing the types of dots 601 used in the structured light pattern 600.

FIG. 8 is a diagram showing the types of dots 601 used in the structured light pattern 600.

FIG. 9 is a diagram showing a specific example of the structured light pattern used in the present disclosure.

FIG. 10 is a diagram for explaining a method of generating a structured light pattern.

FIG. 11 is a flowchart showing a processing procedure for creating a structured light pattern.

FIG. 12 is a diagram showing a specific example of the structured light pattern used in the present disclosure.

FIG. 13 is a diagram showing verification results of attribute values set for each group of 33 dots included in the structured light pattern shown in FIG. 12.

FIG. 14 is a flowchart showing a processing procedure for a corresponding point information acquisition unit 204 to acquire the corresponding point information.

FIG. 15 is a flowchart showing a processing procedure executed by the image projection system 100 during a projection status checking operation.

FIG. 16 is a diagram illustrating a projection image including geometric distortion.

FIG. 17 is a diagram illustrating a projection image after geometric correction.

### DESCRIPTION OF EMBODIMENTS

Hereinafter, embodiments of the present disclosure will be described in detail with reference to the drawings.

### A. System Configuration

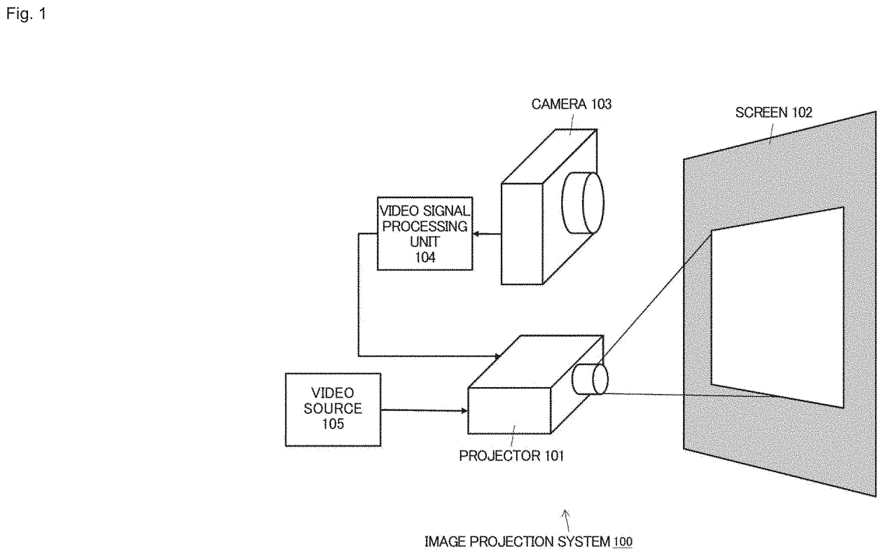

FIG. 1 schematically shows an example of an external configuration of an image projection system 100 to which the present disclosure is applied. The illustrated image projection system 100 includes a projector 101 that projects a video on a screen 102, a camera 103 that captures a projection image on the screen 102, a video signal processing unit 104 that performs development or the like on the captured signal of the camera 103, and a video source 105 that supplies a video signal for projection to the projector 101.

The method by which the projector 101 projects a video is not particularly limited. Further, the structure, shape, and material of the screen 102 are not particularly limited. The screen 102 may be a projection screen made of cloth or the like, or may be a wall of a room, an outer wall of a building, or the like. The video source 105 is arbitrary, and may be an information terminal such as a disc playback device or a personal computer, a cloud, or the like. Further, a communication path through which the video source 105 transmits a video signal to the projector 101 is not particularly limited, and may be wired cables such as high definition multimedia interface (HDMI (registered trademark)), video graphic array (VGA), universal serial bus (USB), and the like or wireless communication such as Wi-Fi (registered trademark).

The projector 101 projects the video supplied from the video source 105 on the screen 102 during a normal projection operation. Further, the projector 101 projects a test pattern on the screen 102 when checking the projection status. In this embodiment, it is assumed that the projection status checking operation is performed by online sensing as described later. Therefore, the projector 101 embeds a test pattern in an original video and projects it on the screen 102. The projector 101 may internally store a test pattern generated by an external device (not shown) in advance and read and use the same during a projection status checking operation. Alternatively, the projector 101 may have a function of internally generating a test pattern.

The camera 103 captures a projection image on the screen 102 during the projection status checking operation. The video signal processing unit 104 performs signal processing such as development on the captured signal of the camera 103, and outputs the signal to the projector 101. Alternatively, the camera 103 may constantly capture the projection image on the screen 102, and the projector 101 may acquire the video from the video signal processing unit 104 during the projection status checking operation.

The projector 101 performs geometric correction on the original video based on the correspondence relationship between the original test pattern and the test pattern on the captured image. The principle of geometric correction will be briefly explained.

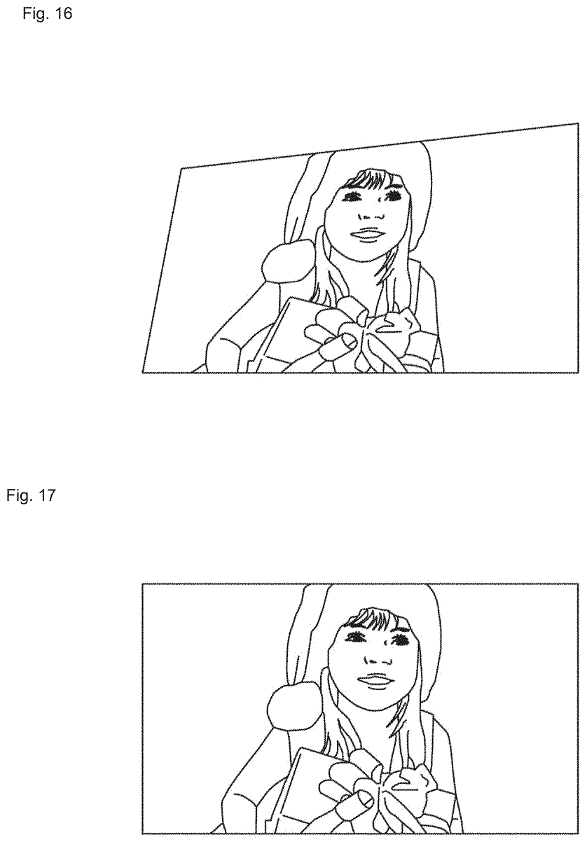

Depending on the posture of the projector 101 with respect to the projection surface of the screen 102, the shape of the projection surface, and the like, the projection image may be distorted as shown in FIG. 16, for example, and may be difficult to see. In such a case, by performing geometric correction such as canceling the distortion on the original image projected by the projector 101, the distortion is reduced and an image close to the original image is projected as shown in FIG. 17 so that it can be easily seen.

The geometric correction of the projection image can be manually performed by an operator or the like who operates the projector 101, but the work is complicated. Therefore, in the image projection system 100 according to the present embodiment, a method is used in which a projection image of the projector 101 is captured by using the camera 103, and geometric correction is automatically performed using the captured image.

When geometric correction of a projection image is performed using the camera 103, it is necessary to obtain a corresponding point between the original projection image and the captured image. That is, it is necessary to obtain a pixel correspondence relationship between the captured image obtained by the camera 103 capturing the projection image on the screen 102 and the original image projected by the projector 101. By comparing the positions of the corresponding points between the original image and the captured image, it is possible to calculate the distortion at each corresponding point of the captured image, in other words, the projection image projected by the projector 101, and the distortion of the projection image can be reduced by performing geometric correction on the positions of the corresponding points of the original image so as to cancel the distortion.

Checking the projection status of the projector 101 when performing such geometric correction corresponds to acquiring information on the corresponding points between the original image to be projected and the captured image of the projection video on the screen 102.

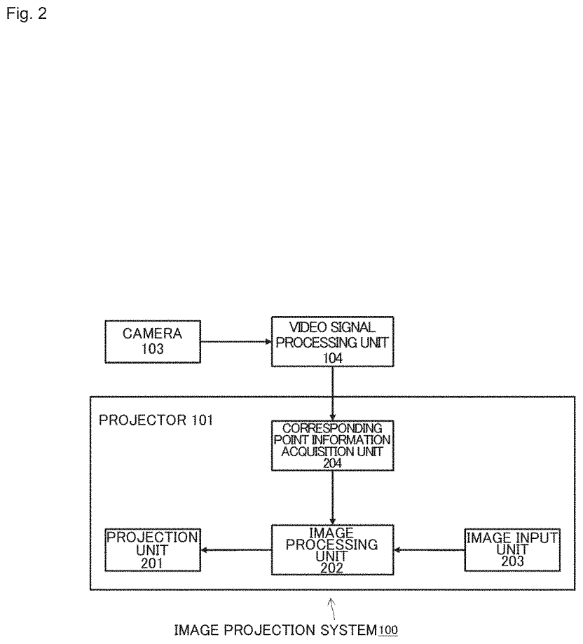

FIG. 2 shows an example of a functional configuration of the image projection system 100. The image projection system 100 includes the projector 101 that projects a video on a screen (not shown in FIG. 2), the camera 103 that captures a projection image on the screen, the video signal processing unit 104 that performs development or the like on the captured image of the camera 103, and the video source (not shown in FIG. 2) that supplies a video signal for projection to the projector 101. The projector 101 includes a projection unit 201, an image processing unit 202, an image input unit 203, and a corresponding store information acquisition unit 204.

The image input unit 203 inputs a video signal from a video source such as a disc playback device, an information terminal, or a cloud.

The image processing unit 202 processes the image to be projected and output from the projection unit 201. The image output from the image processing unit 202 is an input image input from the image input unit 203 and a test pattern held in the image processing unit 102. In this embodiment, online sensing is applied as described later, and the image processing unit 202 outputs an image in which a test pattern is embedded in the input image to the projection unit 201 during the projection status checking operation (or when acquiring corresponding point information).

In the image processing unit 202, the geometric correction of the distortion occurring in the projection image is also performed based on the corresponding point information supplied from the corresponding point information acquisition unit 204. The distortion to be corrected is a distortion based on the posture of the projector 101 with respect to the projection surface and the shape of the projection surface, and may include optical distortion due to the optical system of the projector 101 or the camera 103.

The projection unit 201 projects an image output from the image processing unit 202 on a screen (not shown in FIG. 2). Geometric distortion occurs in the projection image due to the posture of the projector 101 with respect to the projection surface and the shape of the projection surface.

The camera 103 captures a projection image in which a test pattern projected on the screen from the projection unit 201 is embedded during the projection status checking operation (or when acquiring the corresponding point information). The captured image of the camera 103 is supplied to the corresponding point information acquisition unit 204 after the signal processing is performed by the video signal processing unit 104.

The corresponding point information acquisition unit 204 detects a test pattern from a captured image in which a test pattern is embedded, obtains information on a corresponding point between the original projection image and the captured image, and supplies the corresponding point information to the image processing unit 202. In the image processing unit 202, the correction amount for correcting the geometric distortion included in the projection image is calculated based on the corresponding point information, and the geometric distortion is corrected by performing the projective conversion on the output image.

The camera 103 is arranged at a position different from the irradiation position of the projection unit 201, and the optical axis is set so that the capturing range covers the irradiation range of the projection unit 201 as much as possible. When checking the projection status (or when acquiring the corresponding point information), the image in which the test pattern is embedded is projected from the projection unit 201 on the screen, and is captured by the camera unit 104. Then, the corresponding point information acquisition unit 204 extracts a test pattern from the captured image, obtains information on the corresponding point between the original projection image and the captured image, and outputs the corresponding point information to the image processing unit 202. In the image processing unit 202, when the correction parameters for geometrically correcting the projection image are calculated based on the corresponding point information, the correction parameters are applied to all the images input from the image input unit 203, and an image in which the geometric distortion is corrected is irradiated from the projection unit 201.

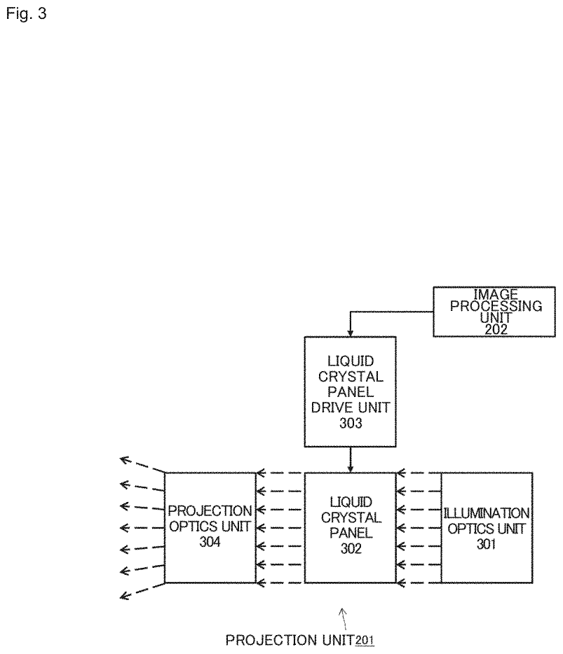

FIG. 3 shows an example of the internal configuration of the projection unit 201. The illustrated projection unit 201 includes an illumination optics unit 301, a liquid crystal panel 302, a liquid crystal panel drive unit 303, and a projection optics unit 304.

The liquid crystal panel drive unit 303 drives the liquid crystal panel 302 based on the image signal input from the image processing unit 202, and draws a projection image on the display screen thereof. The illumination optics unit 301 irradiates the liquid crystal panel 302 from the back surface. When the image projection system 100 is a pico projector, for example, a light emitting diode (LED) or a laser is used as the light source of the illumination optics unit 301. The projection optics unit 304 magnifies and projects the light transmitted through the liquid crystal panel 302 on the screen (not shown in FIG. 3) via the projection optics unit 304. An input image to the image input unit 203 is projected from the projection unit 201. Further, during the projection status checking operation (or when acquiring the corresponding point information), the test pattern embedded in the input image to the image input unit 203 is projected from the projection unit 201. The projection optics unit 304 is made up of one or two or more optical lenses. It is assumed that the projection optics unit 304 has lens distortion, and therefore, the geometric distortion of the projection image is caused by the lens distortion as well as the posture of the projector 101 and the shape of the projection surface.

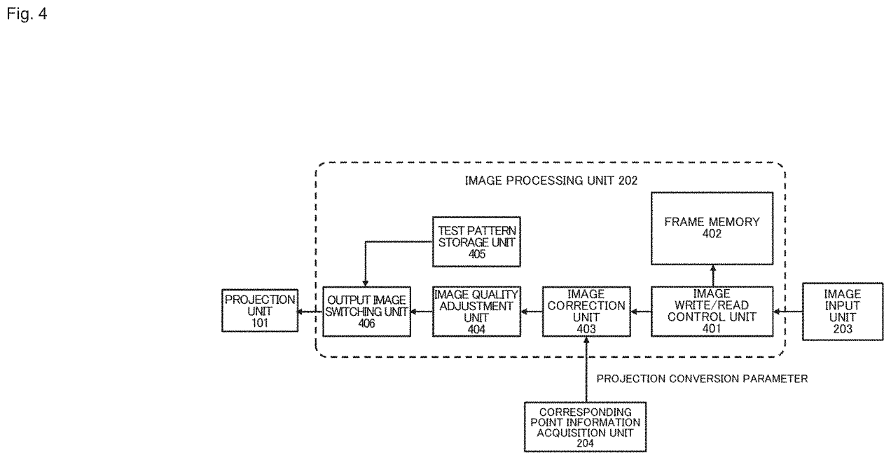

FIG. 4 shows an example of the internal configuration of the image processing unit 202. The illustrated image processing unit 202 includes an image write/read control unit 401, a frame memory 402, an image correction unit 403, an image quality adjustment unit 404, a test pattern storage unit 405, and an output image switching unit 406.

The image supplied from the image input unit 203 is stored in the frame memory 402. The image write/read control unit 401 controls writing and reading of an image frame to the frame memory 402.

The image correction unit 403 corrects the image read from the frame memory 402 based on the corresponding point information received from the corresponding point information acquisition unit 204 so that the geometric distortion is eliminated when the image is projected from the projection unit 201 on the subject. The geometric correction has been described with reference to FIGS. 16 and 17, but is not limited thereto.

The image quality adjustment unit 404 adjusts the image quality such as luminance, contrast, synchronization, tracking, color depth, and hue so that the projection image after distortion correction is in a desired display state.

The test pattern storage unit 405 stores a test pattern to be embedded in the projection image during the projection status checking operation of the projector 101 (or when acquiring the corresponding point information). The test pattern storage unit 405 may store a test pattern generated in advance by an external device (not shown), or a function of generating a test pattern may be provided in the image processing unit 202 (or the projector 101). As will be described later, in the present disclosure, an imperceptible structured light (ISL) method of online sensing is applied to the acquisition of corresponding point information, and the test pattern is a structured light pattern. The output image switching unit 406 switches the output image so as to output an image in which the test pattern read from the test pattern storage unit 405 is embedded during the projection status checking operation (or when acquiring the corresponding point information).

### B. Online Sensing

Although the projection function is checked when the projector 101 is installed, the posture of the projector 101 and the shape of the projection surface of the screen 102 may change even when a video is being projected. Therefore, even after the projection is started, it is necessary to check the projection status of the projector 101 and perform the geometric correction of the projection image again.

It is not preferable for the presenter and the audience to stop the projection operation and interrupt the presentation every time the projection status of the projector is checked. Therefore, the image projection system 100 according to the present embodiment checks the projection status of the projector 101 while continuing the projection operation of the projector 101, that is, performs processing of acquiring information on the corresponding points between the original image and the captured image of the camera 103.

Examples of the online sensing technology include a method using invisible light such as infrared light, a method using an image feature amount such as scale invariant features transform (SIFT), and an ISL method. In the case of the method using invisible light such as infrared light, a projector (for example, an infrared projector) that projects invisible light is further required, which increases the cost. Further, in the case of the method using an image feature amount such as SIFT, it is difficult to detect the corresponding points with stable accuracy because the detection accuracy and the density of the corresponding points depend on the projection image content.

In contrast, in the case of the ISL method, since visible light is used, it is possible to suppress an increase in system components (that is, an increase in cost). In addition, the ISL method can detect corresponding points with stable accuracy without depending on the projection image.

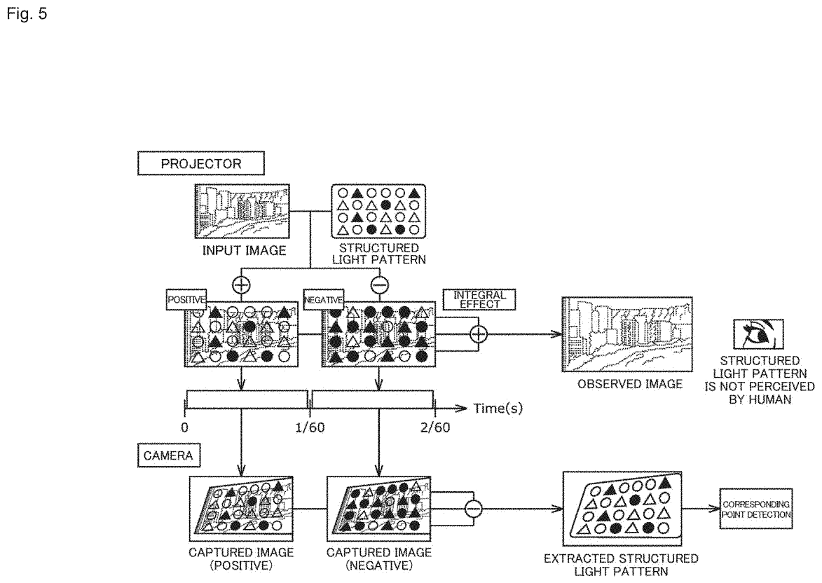

The operating principle of the ISL method will be described with reference to FIG. 5. The projector 101 adds a predetermined structured light pattern to a certain frame of an input image to generate a frame image in which a positive image of the structured light pattern is combined with the input image, and subtracts the structured light pattern from a subsequent frame of the input image to generate a frame image in which a negative image of the structured light pattern is combined with the input image. Then, the projector 101 continuously projects the positive image frame and the negative image frame alternately for each frame. Two consecutive frames of the positive image and the negative image switched at a high speed are added and perceived by the human eye due to the integral effect. As a result, it is difficult for the user observing the projection image to recognize the structured light pattern embedded in the input image, that is, the structured light pattern becomes invisible from the observed image.

The camera 103 captures the projection images of the positive image frame and the negative image frame. Then, the corresponding point information acquisition unit 204 extracts only the structured light pattern included in the captured image by obtaining the difference between the captured images of both frames. Corresponding points can be detected using this extracted structured light pattern.

In this way, with the ISL method, the structured light pattern can be easily extracted simply by obtaining the difference between the captured images, so it is possible to detect the corresponding points with stable accuracy without depending on the projection image.

Examples of the structured light pattern used in the ISL method include a Gray code and a checker pattern. For details of the Gray code and the checker code, refer to, for example, PTL 1. Since the Gray code or the checker pattern has patterns having a large luminance variation gradient and high spatial regularity, they are easily perceived by the user who is viewing the projection image, and invisibility may be reduced. The structured light pattern is unnecessary for the image to be projected, and the user's perception of the structured light pattern corresponds to the reduction of the image quality of the projection image. When a Gray code or a checker pattern is used, it is necessary to project a large number of images in order to acquire the corresponding point information. In general, as the number of projection images increases, it becomes more easily perceived by the user, and invisibility may be further reduced. In addition, the time taken for detecting corresponding points increases since a large number of images are projected.

### C. Structure of Structured Light Pattern

In the present disclosure, since visible light is used in online sensing, the ISL method capable of suppressing an increase in system components (that is, an increase in cost) is adopted. Further, in the present disclosure, a structured light pattern that can shorten the detection time while ensuring invisibility by solving the problems in the Gray code or the checker pattern is adopted. Specifically, in the present disclosure, a structured light pattern that combines dots that represent information using a contour or a shape and a luminance variation direction is used for acquiring corresponding point information.

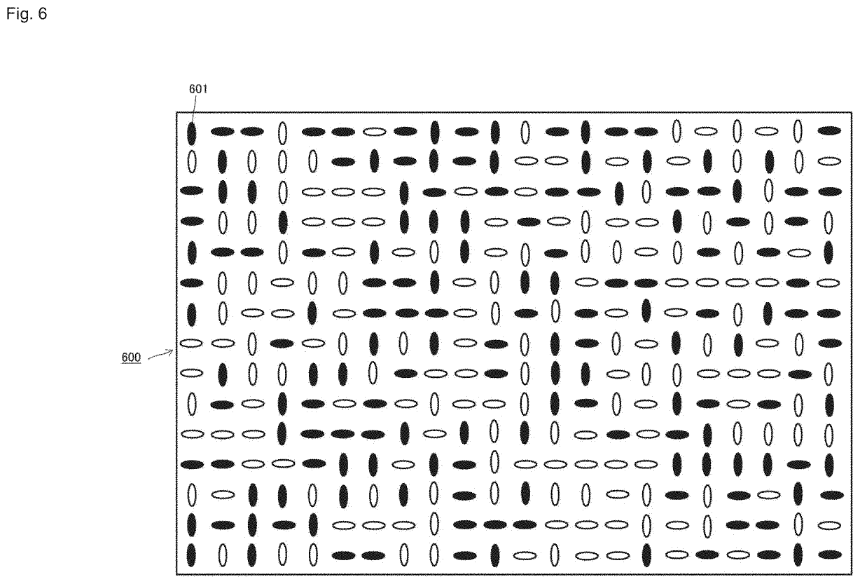

FIG. 6 shows an embodiment of the structured light pattern used in the present disclosure. Structured light patterns are used to detect the corresponding points between the original projection image and the captured image of the projection image. The structured light pattern 600 shown in FIG. 6 is configured by arranging elliptical dots 601 having different luminance values from the periphery in a grid form. When checking the projection status of the projector 101, that is, when acquiring the corresponding point information, the projection image of the image in which the structured light pattern 600 is embedded is captured by the camera 103, and dots 601 are detected from the captured image, whereby the corresponding points between the original projection image and the captured image can be obtained.

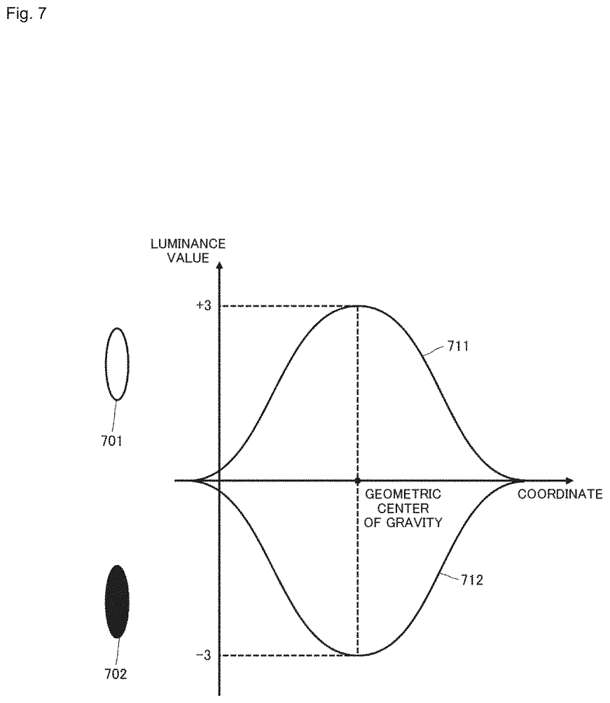

White and black dots 601 in FIG. 6 actually have an elliptical shape having a luminance distribution of a two-dimensional Gaussian function in a positive or negative direction from the periphery toward the center. In this way, the invisibility of the dots 601 can be improved in each of the positive and negative images. FIG. 7 shows the luminance distribution of the dots whose luminance variation directions are the positive direction and the negative direction. As shown in a curve 711, the luminance value of a dot 701 whose luminance variation direction is the positive direction varies in a Gaussian function in the positive direction from the periphery of the ellipse toward the geometric center of gravity. In contrast, as shown in a curve 712, the luminance value of a dot 702 whose luminance variation direction is the negative direction varies in a Gaussian function in the negative direction from the periphery of the ellipse toward the geometric center of gravity. That is, the structured light pattern 600 has two types of dots whose luminance variation directions are opposite to each other.

The two frames of the positive image and the negative image switched at a high speed are added and perceived by the human eye due to the integral effect. As a result, it becomes difficult for the user observing the projection image to recognize the structured light pattern embedded in the image, that is, it becomes invisible. On the other hand, by taking the difference between the captured images obtained by the camera 103 capturing the projection images of the positive image frame and the negative image frame, only the structured light pattern included in the captured image is extracted. Corresponding points are detected using this extracted structured light pattern.

The dots 601 have two kinds of luminance variation directions (represented by white and black in FIG. 6), and have two types of elliptical shapes depending on whether the long axis extends in the horizontal direction or the vertical direction. Therefore, each dot 601 can have 1 bit of information based on the luminance variation direction and 1 bit of information based on the long-axis direction of the elliptical shape, and can have 2 bits of information (that is, 4-valued information) based on combinations of the luminance variation direction and the long-axis direction. However, it is assumed that the white dots in FIG. 6 have a positive luminance variation direction, and the black dots have a negative luminance variation direction.

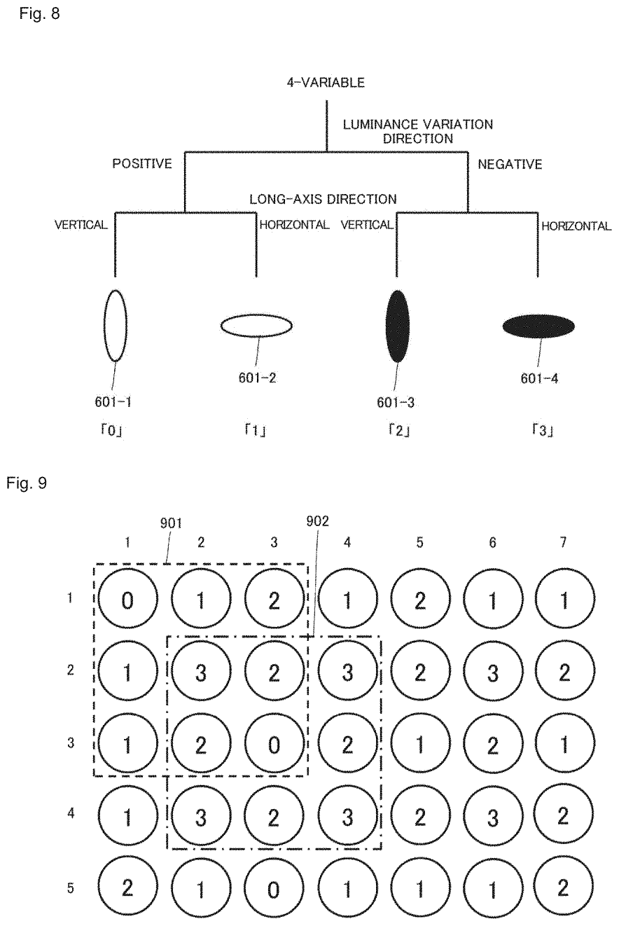

FIG. 8 shows the types of dots 601 used in the structured light pattern 600 in the present embodiment. As shown in the figure, there are four types of dots 601-1, 601-2, 601-3, 601-4 depending on the combination of the luminance variation direction (positive or negative) and the long-axis direction (vertical or horizontal) of the ellipse. Therefore, the dot 601 can represent 2 bits of information. In the following description, the dots 601-1, 601-2, 601-3, 601-4 will be indicated by four attribute values of “0”, “1”, “2”, and “3”, respectively.

### D. Solving Problems of Structured Light Patterns

Using such a structured light pattern that combines dots that represent information using a contour or a shape and the luminance variation direction as shown in FIG. 6, invisibility can be ensured by an integral effect, and a structured light pattern can be extracted by taking the difference between the captured images of two projection images of the positive image frame and the negative image frame. Thus, the time taken for acquiring the corresponding point information can be shortened.

However, there is also a problem in acquiring the corresponding point information using the structured light pattern as shown in FIG. 6. In order to ensure the invisibility of the structured light pattern, the amplitude of the luminance varying in the positive and negative directions is made small (see FIG. 7). Therefore, the detection process is affected by the luminance of the projection image, the luminance fluctuation, and the like, and there is a possibility that dots cannot be detected or the 2 bits of information represented by the dot is erroneously determined.

In the above, it has been described that 2 bits of information is represented by each dot constituting the structured light pattern used in the online sensing of the ISL method. In contrast, the present disclosure further provides two functions, an identification function and an error detection function, to a combination of a plurality of neighboring dots.

The identification function is a function in which an information sequence represented by a combination of a plurality of neighboring dots is unique information within the same structured light pattern, and can be distinguished from other combinations of dots. Therefore, it is possible to acquire the position information of these dots in the structured light pattern based on the information sequence represented by the combination of a plurality of neighboring dots. The corresponding point of an original image can be identified for the combination of dots whose information sequence can be read when online-sensing the captured image of a projection image.

The error detection function is a function that can detect whether or not the information of each dot is erroneously determined depending on whether the information sequence represented by the combination of a plurality of neighboring dots conforms to a predetermined rule or condition. Specifically, it is detected whether or not the information of each dot is erroneously determined depending on whether the sum of the values read from a plurality of neighboring dots conforms to a predetermined rule or condition. Even if the corresponding point information can be acquired based on the information sequence represented by the combination of a plurality of neighboring dots, when an error in the information sequence is detected, the corresponding point information is discarded and not used.

Therefore, the corresponding point information acquisition unit 204 can acquire only the correct corresponding point information, and the image correction unit 403 in the image processing unit 202 can perform correct geometric correction on the projection image based on the correct corresponding point information. Even if all the dots cannot be detected, for example, if the corresponding point information of the four corners around the undetectable dot can be acquired, there is a possibility that the corresponding point information can be estimated by a method such as interpolation. On the other hand, if erroneous corresponding point information based on erroneously determined dots is used, erroneous geometric correction will be performed, and the distortion of the projection image may become rather severe.

The structured light pattern used in the present disclosure will be specifically described. Similarly to FIG. 6, the structured light pattern is made up of an array of dots having 2 bits of information based on the combinations of the luminance variation direction and the long-axis direction. In the following, for the sake of simplification of the drawing, the dots will be indicated by four attribute values of “0”, “1”, “2”, and “3”, respectively, according to FIG. 8.

FIG. 9 illustrates a group of 7×5 dots arranged in a grid form, which is a part of the structured light pattern used in the present disclosure. It is assumed that FIG. 9 represents a pattern of dots detected according to the operating principle of the ISL method described with reference to FIG. 5.

Conventionally, a method of associating the 2 bits of information represented by each dot detected from the captured image with the dots on the original structured light pattern and calculating the corresponding points on the coordinates based on the position of the center of gravity of the associated dots is used. However, in the structured light pattern used here, the amplitude of the luminance that varies in the positive direction and the negative direction is made small with an emphasis on invisibility (see FIG. 7). Therefore, the detection process is affected by the luminance of the projection image, the luminance fluctuation, and the like, and there is a possibility that dots cannot be detected or the 2 bits of information represented by the dot is erroneously determined.

Therefore, the present disclosure further provides two functions, an identification function and an error detection function, to a combination of a plurality of neighboring dots. In the embodiment shown in FIG. 9, an identification function and an error detection function are provided for each dot group consisting of 3×3 (9) dots as a combination of a plurality of neighboring dots.

First, a dot indicating the attribute value “3” indicating that the dot is the central dot of the 3×3 (9) dots is arranged at the center of the 3×3 (9) dots. As shown in FIG. 9, dots indicating the attribute value “3” are arranged at intervals of 1 dot on the top, bottom, left and right. At positions other than the center of the 3×3 (9) dots, dots indicating any of the attribute values “0”, “1”, and “2” other than the attribute value “3” are arranged.

Here, the constraint condition when creating the structured light pattern is that eight dots are arranged around the dot indicating the attribute value “3” so that the modulo 3 of the sum of the attribute values represented by the eight dots other than the center of the 3×3 (9) dots (that is, around the dot representing the attribute value “3”) is 0, namely a multiple of 3. That is, 3×3 (9) dots are arranged so that the sum of the attribute values represented by the eight dots around the dot representing the attribute value “3” is any one of 0, 3, 6, 9, 12, or 15.

In the example shown in FIG. 9, in the case of 3×3 (9) dots shown by the reference number 901, the sum of the attribute values represented by the eight dots around the dot representing the attribute value “3” is 1+1+0+1+2+2+0+2=9, and the modulo 3 is 0. Further, in the 3×3 (9) dots indicated by the reference number 902, which is moved 1 dot to the right and 1 dot downward from the position indicated by the reference number 901, the sum of the attribute values represented by eight dots around the dot representing the attribute value “3” is 0+2+0+2+1+2+1+1=9, and the modulo 3 is 0.

When the structured light pattern as shown in FIG. 9 is extracted from the image obtained by the camera 103 capturing the projection image of the projector 101 when acquiring the corresponding point information, it is checked whether the sum of the attribute values represented by the eight dots around the dot having the attribute value “3” satisfies the constraint condition that “modulo 3 is 0”. Then, when the constraint condition is satisfied, it is estimated that there is no error in the determination of the 3×3 (9) dots, but when the constraint condition is not satisfied, it is estimated that the determination of the 3×3 (9) dots includes an erroneous determination. That is, by setting this constraint condition when creating the structured light pattern, it is possible to add an error detection function to the structured light pattern. However, since there is a possibility that two or more erroneous determinations cannot be detected only by one error detection using modulo, other error detection methods in addition to (or instead of) the method using modulo may be used.

The 3×3 (9) dots that do not satisfy the above-mentioned constraint condition and are estimated to be erroneously determined are not used in the subsequent corresponding point information acquisition process so as not to acquire erroneous corresponding point information. Alternatively, the corresponding points may be interpolated based on the determination result of 3×3 (9) dots at the four corners around the 3×3 (9) dots estimated to be erroneously determined.

Another constraint condition when creating a structured light pattern is that the sequence of attribute values represented by the eight dots other than the center of the 3×3 (9) dots (that is, around the dot representing the attribute value “3”) does not overlap with other 3×3 (9) dots (that is, it is unique information) within the same structured light pattern.

In the example shown in FIG. 9, in the 3×3 (9) dots indicated by the reference number 901, the sequence of the attribute values represented by the eight dots around the dot representing the attribute value “3” is 11012202. Further, in the 3×3 (9) dots indicated by the reference number 902, which is moved 1 dot to the right and 1 dot downward from the position indicated by the reference number 901, the sequence of attribute values represented by the eight dots around the dot representing the attribute value “3” is 02021211, which does not overlap with the 3×3 dot group indicated by the reference number 901.

In each 3×3 dot group, the sequence of attribute values represented by the eight dots around the dot representing the attribute value “3” is unique information within the same structured light pattern, and can be distinguished from the other 3×3 dot groups. That is, by setting another constraint condition when creating the structured light pattern, it is possible to add an identification function to the structured light pattern.

When creating a structured light pattern, every time the attribute values of a group of 3×3 dots is set, the sequence of attribute values represented by eight dots around the central dot representing the attribute value “3” is generated so as to satisfy the first constraint condition, and the sequence of attribute values is recorded in an association list in association with the pixel positions of the dots. Further, when setting the attribute values of the next 3×3 dot group, the sequence of attribute values represented by the eight neighboring dots is generated so as not to overlap with the sequence of eight attribute values of the 3×3 dot group set in advance similarly while satisfying the first constraint condition, and the sequence of the attribute values is recorded in the association list in association with the pixel positions of the dots.

When acquiring the corresponding point information, the structured light pattern as shown in FIG. 9 is extracted from the image obtained by the camera 103 capturing the projection image of the projector 101, and the sequence of attribute values represented by the eight dots around the dot having the attribute value “3” is acquired. In this way, the pixel positions of the dots (that is, the corresponding point information) can be acquired by referring to the association list. For example, when the sequence “11012202” of eight attribute values is detected from the 3×3 dot group indicated by the reference number 901 and the sequence of the attribute values is referred to in the association list, it is possible to acquire the pixel positions of the dots of the dot group (that is, the corresponding point information). Further, when the sequence “02021211” of eight attribute values is detected from the 3×3 dot group indicated by the reference number 902 and the sequence of the attribute values is referred to in the association list, it is possible to acquire the pixel positions of the dots of the dot group (that is, the corresponding point information) without overlapping with another 3×3 dot group including the 3×3 dot group indicated by the reference number 901.

Here, an example of a processing procedure for creating a structured light pattern used in the present disclosure will be briefly described. However, for the sake of simplification of the explanation, it is assumed that the structured light pattern is made up of a large number of dots arranged in a grid form, and each dot is indicated by the four attribute values of “0”, “1”, “2”, and “3” according to FIG. 8.

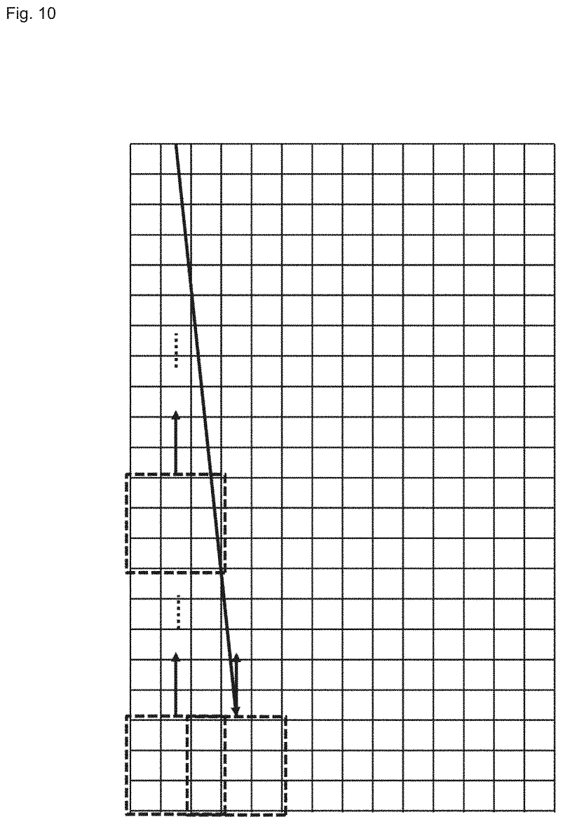

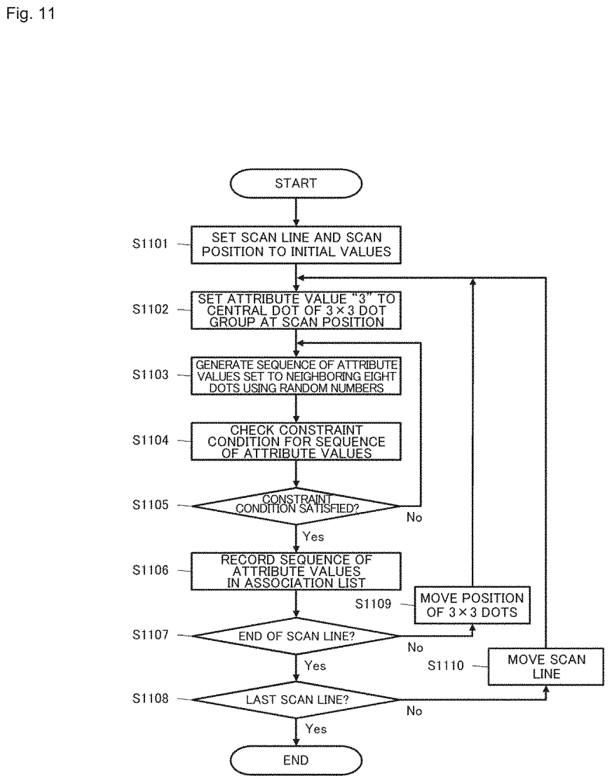

As shown in FIG. 10, the grid in which the dots are arranged is moved horizontally at intervals of one dot in units of 3×3 dots and the attribute values of each dot in the 3×3 dots are generated so as to satisfy the above-mentioned two constraint conditions for each scan position. FIG. 11 shows an example of a processing procedure for creating a structured light pattern in the form of a flowchart.

First, at the current scan position (step S1101), a dot indicating the attribute value “3” indicating that the dot is the central dot of the 3×3 (9) dots is arranged at the center of the 3×3 (9) dots (step S1102).

Next, random values, for example, are generated for each value of eight dots around the dot representing the attribute value “3” (step S1103), and it is checked whether the modulo 3 of the sum of the attribute values is 0, and the sequence of the attribute values represented by the eight neighboring dots does not overlap with the 3×3 (9) dots created in advance (step S1104).

If the generated random numbers do not satisfy at least one constraint condition (No in step S1105), the random numbers are generated again and it is checked whether or not the constraint condition is satisfied.

Then, if the attribute values of the 3×3 (9) dots satisfying the two constraint conditions can be generated (Yes in step S1105), the sequence of attribute values represented by the eight neighboring dots is recorded in the association list in association with the pixel positions of the dots (step S1106).

After setting the attribute value of the 3×3 (9) dots as described above, the position of the 3×3 dot group is moved at intervals of one dot on the current scan line (No in step S1107, step S1109). Further, when the scanning of one line in the horizontal direction is completed (Yes in step S1107), the scan line is moved at intervals of one line in the vertical direction (step S1110). Also on the next scan line, the position of the dot group is moved at intervals of one dot in the horizontal direction in the same manner, and the attribute values of the dots in the 3×3 dot group are generated so as to satisfy the above-mentioned two constraint conditions for each scan position. Then, when all the scan lines are reached (Yes in step S1108) and the setting of the attribute values of all the dots constituting the structured light pattern is completed, this process ends.

The association list that records the correspondence relationship between the sequence of attribute values of eight neighboring dots and the pixel position of each dot is indispensable when the corresponding point information acquisition unit 204 acquires the corresponding point information of the structured light pattern. In the processing procedure shown in FIG. 11, the association list is created at the same time as the creation of the structured light pattern.

The procedure for creating the structured light pattern shown in FIG. 11 is an example, and is not limited to this. If a structured light pattern satisfying the above two constraint conditions can be created, other processing procedures may be adopted.

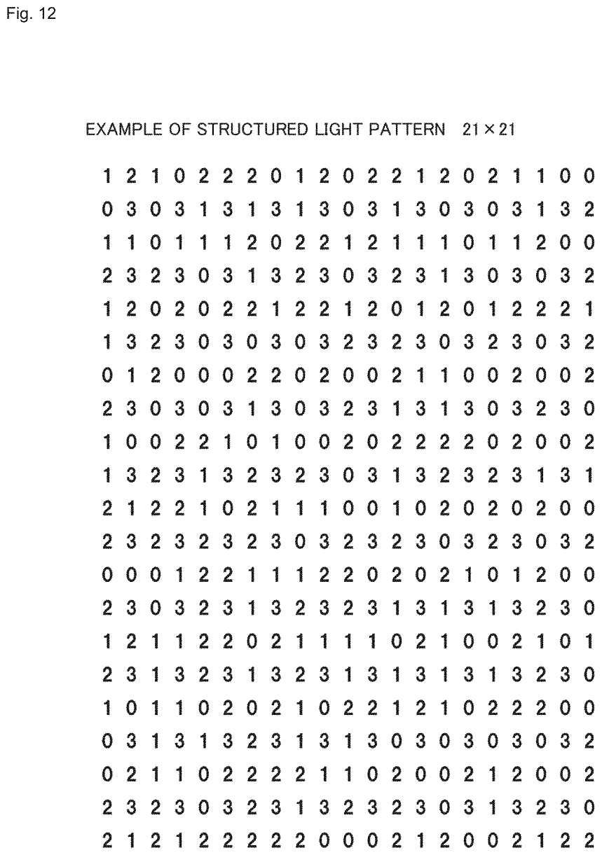

FIG. 9 shows a specific example of a structured light pattern made up of 7×5 dots. FIG. 12 shows an example of a structured light pattern made up of 21×21 dots. A specific example of the structured light pattern shown in FIG. 12 is shown. The structured light pattern shown in FIG. 12 can be generated according to the processing procedure shown in FIG. 11. Further, the attribute values set for each dot of the structured light pattern shown in FIG. 12 satisfy the above-mentioned two constraint conditions.

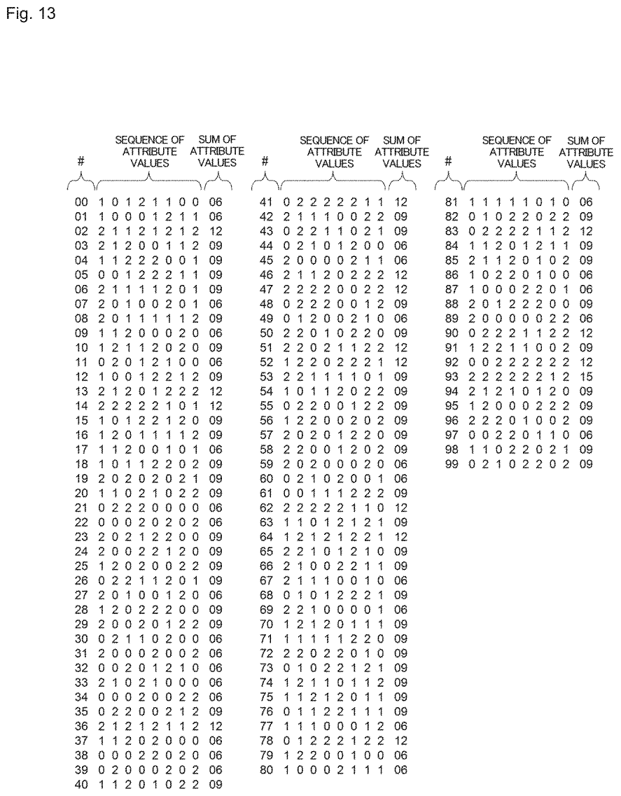

FIG. 13 shows the verification results of the attribute values set for each 3×3 dot group included in the structured light pattern shown in FIG. 12 in a list format. However, each item in the list includes a serial number (#) indicating the order of scanning, the sequence of eight attribute values, and the sum of eight attribute values.

In each item in FIG. 13, the sum of the attribute values represented by the eight dots satisfies the constraint condition that modulo 3 is 0. Therefore, it can be said that the structured light pattern shown in FIG. 12 is generated so as to satisfy the first constraint condition. In the structured light pattern extracted from the captured image of the projection image in which the structured light pattern is embedded when the corresponding point information is acquired, if the sum of the attribute values represented by eight dots around the dot having the attribute value “3” does not satisfy the constraint condition that “modulo 3 is 0”, it can be estimated that an erroneous determination has occurred in the 3×3 dot group.

Further, when comparing the items in FIG. 13, there is no item in which the sequence of attribute values of eight dots overlaps with that of other items. Therefore, it can be said that the sequence of attribute values of all items is unique information, and the structured light pattern shown in FIG. 12 is generated so as to satisfy the second constraint condition. By referring to, in the association list, the sequence of attribute values represented by eight dots around the dot representing the attribute value “3” included in the structured light pattern extracted from the captured image of the projection image in which the structured light pattern is embedded when the corresponding point information is acquired, it is possible to acquire the pixel positions of the dots of the dot group (that is, the corresponding point information).

The structured light pattern satisfying the above-mentioned two constraint conditions and a list thereof, which are created according to the processing procedure shown in FIG. 11 or other processing procedures, are stored in the projector 101 in advance before shipment. Then, the corresponding point information acquisition unit 204 executes the corresponding point information acquisition process using the structured light pattern stored in advance and the association list thereof. Alternatively, the structured light pattern and the association list thereof may be generated in the projector 101 according to the processing procedure shown in FIG. 11 or other processing procedures.

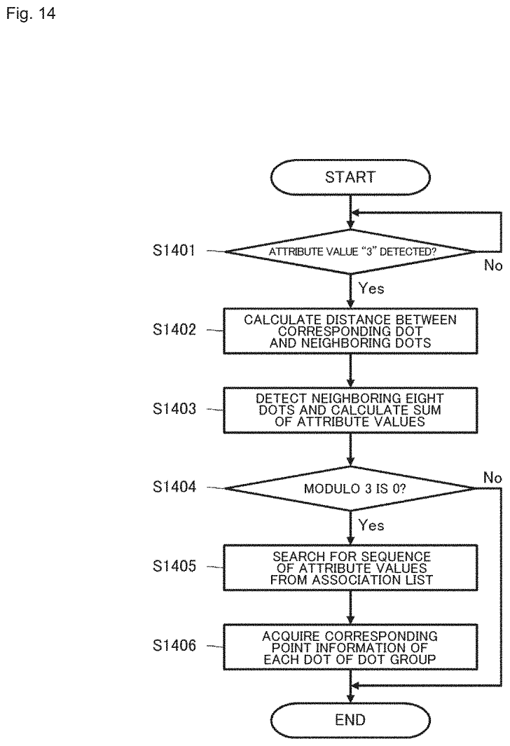

FIG. 14 shows the processing procedure for acquiring the corresponding point information in the corresponding point information acquisition unit 204 in the form of a flowchart. However, FIG. 14 shows the processing after the projection image captured by the camera 103 is processed by the video signal processing unit 105, and the difference between the captured images of the projection images of the positive image frame and the negative image frame is taken to extract the structured light pattern. Further, it is assumed that each dot of the structured light pattern is indicated by four attribute values of “0”, “1”, “2”, and “3”, respectively, according to FIG. 8.

The corresponding point information acquisition unit 204 searches for a dot indicating the attribute value “3” on the current scan line, and when the scan of one line is completed, moves the scan line in the vertical direction and also on the next scan line. Similarly, searches for a dot indicating the attribute value “3”. Then, every time the dot indicating the attribute value “3” is detected, a corresponding point information acquisition process is performed on the 3×3 dot group including the detected dot according to the processing procedure shown in FIG. 14.

When the corresponding point information acquisition unit 204 scans the structured light pattern extracted from the captured image and detects the dot indicating the attribute value “3” (Yes in step S1401), the distance to each dot detected around the dot is calculated (step S1402).

Then, the corresponding point information acquisition unit 204 detects eight dots around the dot indicating the attribute value “3” based on the detection result of the distance between dots, and calculates the sum of the attribute values of the detected eight neighboring dots (step S1403).

Next, the corresponding point information acquisition unit 204 verifies the first constraint condition, that is, checks whether or not the modulo of the sum of the attribute values is 0 (step S1404).

When the modulo of the sum of the attribute values is 0 (Yes in step S1404), it can be seen that the 3×3 dot group including the dot detected in step S1401 satisfies the first constraint condition. The corresponding point information acquisition unit 204 searches for the sequence of attribute values of eight neighboring dots in the association list (step S1405). Based on the second constraint condition, it is guaranteed that only one item will be found in the association list. Then, the corresponding point information acquisition unit 204 acquires the pixel positions of each dot of the 3×3 dot group, that is, the corresponding point information, from the hit item in the association list (step S1406).

On the other hand, when the modulo of the sum of the attribute values is not 0 (No in step S1404), the corresponding point information acquisition unit 204 estimates that there is an erroneous determination in the structured light pattern extracted from the captured image obtained by the camera 103 capturing the projection image and determines that there is no corresponding point information for the 3×3 dot group including the dot detected in step S1401. For the dot group for which it is determined that there is no corresponding point information, the corresponding points may be interpolated based on the determination result of the 3×3 (9) dots at the four corners around the 3×3 (9) dots estimated to be an erroneous determination after the corresponding point information acquisition process is completed for the entire structured light pattern extracted from the captured image of the camera 103.

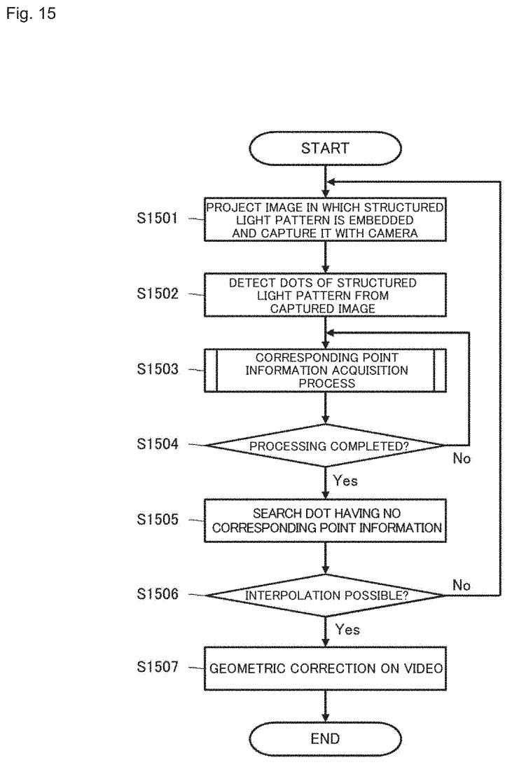

FIG. 15 shows a processing procedure executed by the image projection system 100 during a projection status checking operation in the form of a flowchart.

First, an image in which a structured light pattern is embedded is projected from the projector 101 on the screen 102, and the projection image is captured by the camera 103 (step S1501). The projector 101 alternately and continuously projects a positive image frame in which a structured light pattern is added to the original image and a negative image in which the structured light pattern is subtracted from the original image. Then, the camera 103 captures the projection images of the positive image frame and the negative image frame. When sensing is performed offline instead of online, only the structured light pattern may be projected from the projector 101.

The corresponding point information acquisition unit 204 detects the dots constituting the structured light pattern by obtaining the difference between the captured images corresponding to the positive image frame and the negative image frame (step S1502). Here, it is assumed that the attribute values of each dot are detected as the detection result of the dots arranged in a grid form.

The corresponding point information acquisition unit 204 scans the array of detected dots and searches for the dot indicating the attribute value “3”. Then, when the dot indicating the attribute value “3” is detected, the corresponding point information acquisition unit 204 activates the process shown in FIG. 14 to acquire the corresponding point information of the 3×3 dot group including the detected dot (step S1503).

The corresponding point information acquisition unit 204 scans, for example, the array of detected dots in the horizontal direction, and when the scan of one line is completed, moves the scan line in the vertical direction, and searches for a dot indicating the attribute value “3” on the next scan line.

When the end of the last scan line is reached and the corresponding point information acquisition process is completed for all the dots indicating the attribute values “3” of the detected array of dots (Yes in step S1504), the corresponding point information acquisition unit 204 checks the acquisition result of the corresponding point information. Specifically, the corresponding point information acquisition unit 204 searches for the dots for which the corresponding point information could not be acquired (step S1505), and checks whether the corresponding point information of the dots for which the corresponding point information could not be acquired can be interpolated based on the corresponding point information acquired at four neighboring corners (step S1506).

For example, if the corresponding point information around the dot for which the corresponding point information could not be acquired could not be acquired, the interpolation processing cannot be performed. If the interpolation processing of the corresponding point information of the dots having no corresponding point information of the dots for which the corresponding point information cannot be acquired is not possible (No in step S1506), the process returns to step S1501 and the operation of checking the projection status is restarted from the beginning.

Further, when the interpolation processing of the corresponding point information of the dots having no corresponding point information of the dots for which the corresponding point information cannot be acquired is possible (Yes in step S1506), the corresponding point information acquisition unit 204 performs the interpolation processing. As a result, it is possible to acquire the corresponding point information of all the dots of the structured light pattern extracted from the captured image of the camera 103. If the corresponding point information of all the dots can be acquired by the corresponding point information acquisition process in step S1503, the process is performed in the same manner as in the case where the interpolation process is possible on this flowchart.

Then, the image correction unit 403 performs correction on the image read from the frame memory 402 based on the corresponding point information received from the corresponding point information acquisition unit 204 so as to eliminate geometric distortion when the image is projected on the subject from the projection unit 201 (step S1507).

If erroneous corresponding point information based on erroneously determined dots is used, erroneous geometric correction will be performed, and the distortion of the projection image may become rather severe. In contrast, according to the present disclosure, since erroneous determination of dots can be detected using the first constraint condition added to the structured light pattern, that is, the modulo 3 of the sum of the neighboring 8-bit attribute values is 0, it is possible to prevent erroneous geometric correction.

Further, in the processing procedure shown in FIG. 15, if the acquisition status of the corresponding point information is not good, the measurement needs to be performed again, but the frequency can be reduced.

### INDUSTRIAL APPLICABILITY

The present disclosure has been described in detail above with reference to a specific embodiment. However, it will be apparent to those skilled in the art that modification and substation of the embodiment can be made without departing from the gist of the present disclosure.

The present disclosure can be applied to various types of image projection systems. Further, although detailed description is omitted in the present specification, the present disclosure can also be applied to projector stacking. Further, the present disclosure can be applied not only to the correction of the projection image but also to the technology of embedding information in a video so as not to be perceived by the viewer and the technology of acquiring the information embedded in a video.

In short, the present disclosure has been described in the form of an example, and the contents of the present specification should not be construed in a limited manner. The gist of the present disclosure should be determined in consideration of the claims.

Meanwhile, the present disclosure may also be configured as follows.

(1) An image processing device including: a detection unit that detects an error in a region based on an error detection function assigned to each region of a predetermined pattern extracted from a first image; and an acquisition unit that acquires corresponding point information of a region in an original predetermined pattern based on an identification function assigned to each region of the predetermined pattern extracted from the first image.

(2) The image processing device according to (1), wherein the predetermined pattern is made up of a plurality of dots arranged in a grid form, each dot having an attribute value represented by a predetermined number of bits, and the detection unit detects an error in a region based on whether attribute values of a plurality of dots in a region made up of N×M dots satisfy a first constraint condition.

(3) The image processing device according to (2), wherein each dot has an attribute value represented by 2 bits of 0 to 3, the original predetermined pattern is configured to satisfy the first constraint condition for each of the regions made up of 3×3 dots that a central dot has an attribute value of 3 and the modulo 3 of a sum of attribute values of eight dots around the central dot is 0, and the detection unit detects an error in a region made up of 3×3 dots based on whether the modulo 3 of the sum of the attribute values of eight dots around the dot having the attribute value of 3 detected from the extracted predetermined pattern is 0.

(4) The image processing device according to any one of (1) to (3), wherein the acquisition unit acquires corresponding point information of a region in which an error is not detected by the detection unit.

(5) The image processing device according to any one of (1) to (4), wherein the predetermined pattern is made up of a plurality of dots arranged in a grid form, each dot having an attribute value represented by a predetermined number of bits, and the acquisition unit acquires corresponding point information of a region in an original predetermined pattern based on a second constraint condition set to a sequence of attribute values of a plurality of dots in a region made up of N×M dots.

(6) The image processing device according to (5), wherein each dot has an attribute value represented by 2 bits of 0 to 3, the original predetermined pattern is configured to satisfy the second constraint condition for each of the regions made up of 3×3 dots that a central dot has an attribute value of 3 and a sequence of attribute values of eight dots around the central dot is unique, and the acquisition unit acquires corresponding point information based on a comparison result between the sequence of the attribute values of eight dots around the dot having the attribute value of 3 detected from the extracted predetermined pattern and a sequence of attribute values in an original predetermined pattern.

(7) The image processing device according to any one of (1) to (6), wherein the first image is a captured image obtained by the camera capturing a projection image of a projector.

(8) The image processing device according to any one of (1) to (7), wherein the projector projects an image in which the predetermined pattern is embedded, and the predetermined pattern embedded in the projection image is extracted from the first image obtained by the camera capturing the projection image of the projector.

(9) The image processing device according to any one of (1) to (8), wherein the predetermined pattern is configured by arranging dots having an elliptical shape in a grid form, the dots having two types of luminance variation directions, a positive direction and a negative direction, and two types of long-axis directions.

(10) An image processing method including: a detection step of detecting an error in a region based on an error detection function assigned to each region of a predetermined pattern extracted from a first image; and an acquisition step of acquiring corresponding point information of a region in an original predetermined pattern based on an identification function assigned to each region of the predetermined pattern extracted from the first image.

(11) An image projection system including: a projector; a camera that captures a projection image of the projector; a detection unit that extracts a predetermined pattern from a captured image obtained by the camera capturing a projection image of an image in which the predetermined pattern is embedded, projected by the projector and detects an error in each region of the extracted predetermined pattern based on an error detection function assigned to each of the predetermined pattern; an acquisition unit that acquires corresponding point information for each region of the extracted predetermined pattern based on an identification function assigned to each region of the predetermined pattern; and an image correction unit that corrects an image projected from the projector based on the acquired corresponding point information.

### REFERENCE SIGNS LIST

100 Image projection system
101 Projector
102 Screen
103 Camera
104 Video signal processing unit
105 Video source
201 Projection unit
202 Image processing unit
203 Image input unit
204 Corresponding point information acquisition unit
301 Projection optics unit
302 Liquid crystal panel
303 Liquid crystal panel drive unit
304 Illumination optics unit
401 Image write/read unit
402 Frame memory
403 Image correction unit
404 Image quality adjustment unit
405 Output image switching unit

1. An image processing device comprising:
a detection unit that detects an error in a region based on an error detection function assigned to each region of a predetermined pattern extracted from a first image; and
an acquisition unit that acquires corresponding point information of a region in an original predetermined pattern based on an identification function assigned to each region of the predetermined pattern extracted from the first image.

2. The image processing device according to claim 1, wherein
the predetermined pattern is made up of a plurality of dots arranged in a grid form, each dot having an attribute value represented by a predetermined number of bits, and
the detection unit detects an error in a region based on whether attribute values of a plurality of dots in a region made up of N×M dots satisfy a first constraint condition.

3. The image processing device according to claim 2, wherein
each dot has an attribute value represented by 2 bits of 0 to 3,
the original predetermined pattern is configured to satisfy the first constraint condition for each of the regions made up of 3×3 dots that a central dot has an attribute value of 3 and the modulo 3 of a sum of attribute values of eight dots around the central dot is 0, and
the detection unit detects an error in a region made up of 3×3 dots based on whether the modulo 3 of the sum of the attribute values of eight dots around the dot having the attribute value of 3 detected from the extracted predetermined pattern is 0.

4. The image processing device according to claim 1, wherein
the acquisition unit acquires corresponding point information of a region in which an error is not detected by the detection unit.

5. The image processing device according to claim 1, wherein
the predetermined pattern is made up of a plurality of dots arranged in a grid form, each dot having an attribute value represented by a predetermined number of bits, and
the acquisition unit acquires corresponding point information of a region in an original predetermined pattern based on a second constraint condition set to a sequence of attribute values of a plurality of dots in a region made up of N×M dots.

6. The image processing device according to claim 5, wherein
each dot has an attribute value represented by 2 bits of 0 to 3,
the original predetermined pattern is configured to satisfy the second constraint condition for each of the regions made up of 3×3 dots that a central dot has an attribute value of 3 and a sequence of attribute values of eight dots around the central dot is unique, and
the acquisition unit acquires corresponding point information based on a comparison result between the sequence of the attribute values of eight dots around the dot having the attribute value of 3 detected from the extracted predetermined pattern and a sequence of attribute values in an original predetermined pattern.

7. The image processing device according to claim 1, wherein
the first image is a captured image obtained by the camera capturing a projection image of a projector.

8. The image processing device according to claim 1, wherein
the projector projects an image in which the predetermined pattern is embedded, and
the predetermined pattern embedded in the projection image is extracted from the first image obtained by the camera capturing the projection image of the projector.

9. The image processing device according to claim 1, wherein
the predetermined pattern is configured by arranging dots having an elliptical shape in a grid form, the dots having two types of luminance variation directions, a positive direction and a negative direction, and two types of long-axis directions.

10. An image processing method comprising:
a detection step of detecting an error in a region based on an error detection function assigned to each region of a predetermined pattern extracted from a first image; and
an acquisition step of acquiring corresponding point information of a region in an original predetermined pattern based on an identification function assigned to each region of the predetermined pattern extracted from the first image.

11. An image projection system comprising:
a projector;
a camera that captures a projection image of the projector;
a detection unit that extracts a predetermined pattern from a captured image obtained by the camera capturing a projection image of an image in which the predetermined pattern is embedded, projected by the projector and detects an error in each region of the extracted predetermined pattern based on an error detection function assigned to each of the predetermined pattern;
an acquisition unit that acquires corresponding point information for each region of the extracted predetermined pattern based on an identification function assigned to each region of the predetermined pattern; and
an image correction unit that corrects an image projected from the projector based on the acquired corresponding point information.
